(19) United States
(12) Patent Application Publication
(10) Pub. No.: US 2005/0047802 A1
(43) Pub. Date: Mar. 3, 2005

(54) Post-detection, fiber optic dispersion compensation using adjustable infinite impulse response filter employing trained or decision-directed adaptation

(75) Inventors: Lonnie Scott Jaynes, Melbourne, FL (US); Jerry Busby Wood, Melbourne, FL (US)

Correspondence Address: Allen, Dyer, Doppelt, Milbrath & Gilchrist, P.A.;1401 Citrus Center, 255 South Orange Avenue, Post Office Box 3791, Orlando, FL, 32802-3791, US

(73) Assignee: HARRIS CORPORATION, MELBOURNE, FL (US)

(21) Appl. No.: 10/653,317

(22) Filed: Sep. 2, 2003

(51) Int. Cl. H04B 10/08

(52) U.S. Cl. 398/208

(57) ABSTRACT

An adaptive infinite impulse response (IIR) filter compensates for dispersive distortion in a fiber optic channel. The weighting coefficients of the IIR filter are updated in accordance with an error signal obtained by differentially combining the output of the IIR filter with downstream decision values or with an undistorted training signal. Undistorted training signals may be derived from training patterns (e.g., preamble) expressly transmitted for the purpose by the upstream transmitter, or from non-training, but known or predictable patterns transmitted by the upstream transmitter.

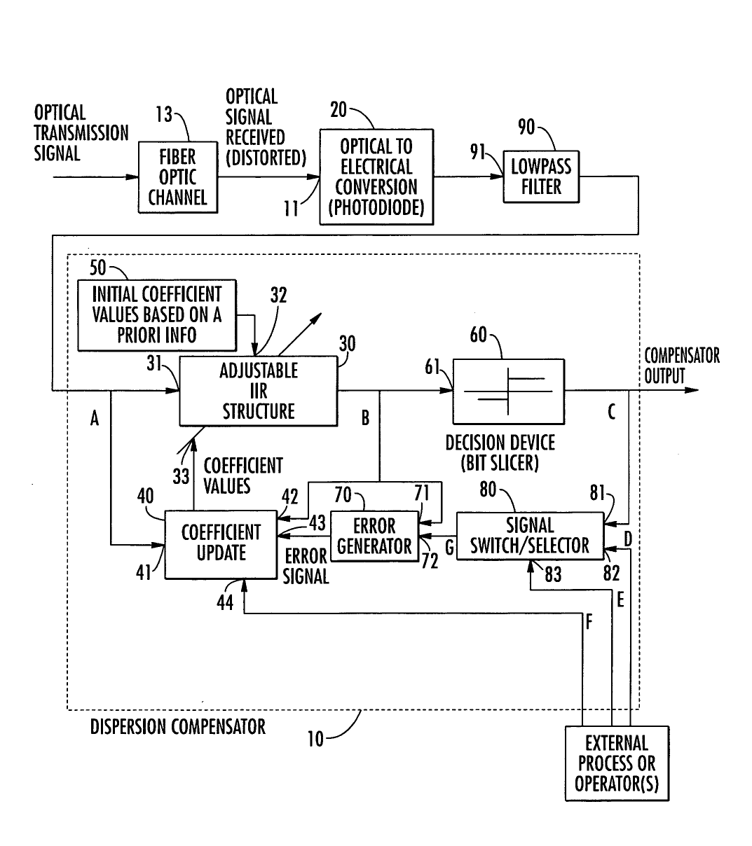

### FIELD OF THE INVENTION

The present invention relates in general to communication systems and subsystems therefor, and is particularly directed to a method and an apparatus for compensating for dispersive distortion in a communication channel, particularly a fiber optic channel, by means of an adaptive infinite impulse response (IIR) filter installed in an electrical signal processing path of an opto-electronic receiver, wherein the weighting coefficients of the IIR filter are updated in accordance with an error signal obtained by differentially combining the output of the IIR filter with downstream decision values or with an undistorted training signal.

### BACKGROUND OF THE INVENTION

A number of communication networks and systems, such as, but not limited to high data rate optical communication systems, employ communication channels that are dispersive—in that they cause the energy of a respective signal component to be dispersed or spread in time as it is transported over the channel. In an effort to reduce the effects of dispersion, some systems predistort the signal in a manner that is intended to be ‘complementary’ to the effect of the channel, so that ‘optimally’ at the receiver the original signal, prior to the predistortion operation, may be recovered. Other systems attempt to ameliorate the problem by dealing directly with the channel itself, such as by using dispersion compensating fibers (DCFs). These approaches can be difficult or expensive to apply under various conditions and, from a functional and architectural standpoint, are relatively rigid, so that they tend to be easily affected by operational or environmental changes, such as mechanical vibration or variations in temperature. In addition, the desire to use channel multiplexing (e.g., wavelength division multiplexing (WDM)) in fiber optic cables, increased data rates, and longer uninterrupted cable lengths complicate and exacerbate the deficiencies of traditional compensation schemes.

### SUMMARY OF THE INVENTION

In accordance with the present invention, problems of conventional methodologies of handing channel dispersion in a high data rate optical communication system, such as those described above, are effectively obviated by means of a post-detection adaptive IIR filter inserted in the electronic signal processing path of the output of an opto-electronic receiver, wherein the weighting coefficients of the IIR filter are updated in accordance with an error signal obtained by differentially combining the output of the IIR filter with downstream decision values for ‘decision-directed adaptation’ mode, or with an undistorted training signal for ‘trained adaptation’ mode.

In decision-based adaptation mode, coefficient updates are based upon a comparison of the output of the IIR filter with the output of a bit slicer that is coupled to the output of the IIR filter. An error generator performs a prescribed differential combining operation on its two inputs and supplies an error signal to an IIR filter coefficient generator that is based on the difference (or dissimilarity or variance) between the initially filtered data and the decisions generated by the bit slicer. In this mode, IIR filter coefficients can be updated on a continuous basis by enabling a coefficient update process as data is received and processed by the IIR filter. The onset time and duration of coefficient update processing is determined by the value (enable/disable) of a coefficient update control signal generated by an operator or process external of the compensator and coupled to a coefficient update unit.

In trained adaptation mode, coefficient updates are based upon a comparison of the output of the IIR filter with an undistorted but corresponding training signal supplied to the error generator. In trained adaptation mode, training signals are derived either from training patterns expressly transmitted for the purpose by the upstream transmitter or from known or predictable patterns not explicitly transmitted for compensator training. As in the decision-based adaptation mode, the coefficient update control signal is used to enable/disable the coefficient update process. In trained adaptation mode, activation/deactivation of the coefficient update process is synchronized with the detection or availability of training signal data. Training signal data is generated by an external process or operator and it is time-aligned with received data being processed by the compensator.

In addition to using one of these two modes exclusively, the invention also may use both filter adaptation modes, each being applied at different times under the control of an external process or operator. In this combined mode of operation, the IIR filter coefficients can be updated according to a range of different criteria and schedules depending on the type and quality of data available so as to optimize filter performance.

### DESCRIPTION OF THE DRAWINGS

The single Figure diagrammatically illustrates a preferred, but non-limiting embodiment of the adaptive IIR filter-based fiber optic dispersion compensator along with coefficient updating components and architecture of the present invention.

### DETAILED DESCRIPTION

Before describing in detail the adaptive infinite impulse response (IIR) dispersion compensator of the present invention, it should be observed that the invention resides primarily in prescribed modular arrangements of conventional digital communication circuits and associated digital signal processing components and attendant supervisory control circuitry therefor, that controls the operations of such circuits and components. In a practical implementation that facilitates their being packaged in a hardware-efficient equipment configuration, these modular arrangements may be readily implemented in different combinations of field programmable gate arrays (FPGAs), microwave monolithic integrated circuits (MIMICs), application specific integrated circuit (ASIC) chip sets, and digital signal processing (DSP) cores.

Consequently, the configuration of such arrangements of circuits and components and the manner in which they are interfaced with other communication equipment have been illustrated in the drawings by a readily understandable block diagram, which shows only those specific details that are pertinent to the present invention, so as not to obscure the disclosure with details which will be readily apparent to those skilled in the art having the benefit of the description herein. Thus, the block diagram illustration is primarily intended to show the major components of the invention in a convenient functional grouping, whereby the present invention may be more readily understood.

Attention is now directed to the single Figure, wherein a preferred, but non-limiting, embodiment of the present invention is diagrammatically illustrated as comprising an input port 11, to which an optical communication signal, such as that transported over a dispersive optical fiber 13, is coupled. As a non-limiting example, the optical communication signal may comprise a conventional synchronous optical network (SONET)-based optical communication signal, such as a SONET STS-192 signal, which contains 384 frame synchronization bytes (a priori known) in each 125-microsecond time interval (192 A1 octets and 192 A2 octets).

Input port 11, consisting of a suitable optical coupler (not shown), is coupled to an opto-electronic conversion unit, such as a photodiode detector 20, which converts the received optical communication signal into an electrical signal. This electrical signal is representative of the optical communication signal as received from the dispersive fiber and, as such, contains both the desired but unknown information signal component and auxiliary known information, such as framing components of the optical communication signal, as well as any (dispersive) distortion that has been introduced into the optical communication signal as a result of its transport over the fiber optic channel 13.

The output of the photodiode 20 is coupled to the input port 91 of a lowpass filter 90. The lowpass filter is used to suppress undesirable out-of-band (high-frequency) components present in the photodiode output signal. The output of the lowpass filter 90 constitutes a compensator input signal, which is coupled to an input port 31 of a controllably adjustable IIR filter 30 and to an input port 41 of a coefficient update unit 40 within a dispersion compensator 10. IIR filter 30 is coupled to an associated memory 50 , which supplies to the filter an initial set of weighting coefficient values, based upon a priori knowledge of the general characteristics of the channel. The IIR filter 30 produces an adjustable IIR output signal, which is coupled to the input port 61 of a (binary) decision circuit or bit slicer 60. The output of decision circuit 60 represents the detected and compensated data stream. The output of the IIR filter 30 is additionally coupled over path B to input port 42 of the coefficient update unit 40, and to the first input port 71 of an error generator unit 70. Error generator 70 has a second input port 72 coupled over path G to the output of a signal switch/selector 80. Signal switch 80 connects one of its two input ports, 81 and 82, with its output port, according to predefined signal values appearing on a switch control input port 83 from path E.

The training signal is a prescribed pattern that is known to the receiver, and may comprise a training preamble that is transmitted periodically from the upstream transmitter at predefined repetition intervals. A copy of this training signal is stored in the receiver and can be used during a time that the training sequence is being transmitted by the transmitter to adjust or adapt the coefficients of the compensator's IIR filter to channel conditions or state. The training sequence need not be a training signal as such, however. It may correspond to some other a priori known or predictable bit pattern that is transmitted by the transmitter.

As a non-limiting example, such a predictable bit pattern may correspond to the consecutive frame synchronization patterns or octets that occur in SONET data, referenced above. In order to take advantage of such data for compensator training purposes, frame synchronization octets may initially be detected in the received data stream (or some derivative thereof) and then time-aligned or synchronized with undistorted versions of the synchronization bit patterns. Synchronized distorted and undistorted versions of signals based on the detected synchronization bit patterns may then be applied to the coefficient update unit 40 and to the error generator 70 (through the signal selector 80), respectively, at process-determined times to update IIR filter coefficients. This process of known pattern detection and synchronization for the purpose of compensator or equalizer training may be of the type described in our co-pending U.S. patent application Ser. No. 10/***,***, filed on Jun. 16, 2003, entitled: “Updating Adaptive Equalizer Coefficients Using Known or Predictable Bit Patterns Distributed Among Unknown Data” (hereinafter referred to as the '*** application, assigned to the assignee of the present application and the disclosure of which is incorporated herein.

Relative to the present invention, training signals with associated control (“gating”) signals are generated by an external process or operator (which may correspond to that described in the '*** application) and are coupled to the error generator 70 through the signal selector 80 and to the coefficient update unit 40. Signals containing channel-distorted patterns useful for compensator training are coupled from path A to input port 41 of the coefficient update unit 40. Signals containing corresponding undistorted versions of the patterns are coupled over path D to input port 82 of the signal selector 80. A coefficient update control signal that is synchronized with the occurrence of detected training patterns is coupled over path F to input port 44 of the coefficient update unit 40. It is important to note that different levels of delay (not shown in Figure) may be required along respective signal paths A, B, and C, in order to achieve proper compensator operation. These delays may actually be incorporated in selected compensator components, such as the coefficient update unit 40, error generator 70, and the signal switch 80.

Error generator 70 differentially combines signals present on input ports 71 and 72 and places the results on its output port, which is coupled to the error input port 43 of coefficient update unit 40. Depending on the coefficient update operator employed, and in addition to the error signal, the coefficient update unit 40 may require as input signals the input and output signals of the adjustable IIR filter. These signals are coupled to respective input ports 41 and 42 of the coefficient update unit. A coefficient update operator (such as the IIR least mean square (LMS) algorithm, IIR sequential regression (SER) algorithm, or other similar algorithm) implemented in the coefficient update unit 40 produces updates for the adjustable IIR filter's weighting coefficients according to the state or value of an update control signal coupled to input port 44. The update control signal enables and disables the coefficient update unit and is generated by an external process. Enabling and disabling of the coefficient update process may be done according to a range of criteria including the successful detection and availability of suitable training patterns. With sufficient internal buffering included on input data paths, the coefficient update unit can be designed or configured to perform coefficient updates at rates lower than the filtering rate of the IIR structure itself. This partial decoupling of IIR filtering and coefficient update processes improves compensator design flexibility and eases overall implementation. In addition, the coefficient update unit 40 may contain special functions or operators for ‘whitening’ or synthesizing new data from raw signal input data that is better suited for the coefficient update process.

Whenever the coefficient update process is based upon the use of output decisions from the binary decision device 60, it is operating in the ‘decision-directed adaptation’ mode. This mode is invoked by selecting the decision device 60 output on path C via signal switch 80 and enabling the coefficient update unit 40 using a control signal coupled to its input port 44. Whenever the coefficient update process is based upon the use of training signals constructed of known bit patterns, it is operating in the ‘trained adaptation’ mode. This mode is invoked by selecting a training signal input on path D via signal switch 80 and enabling the coefficient update unit 40 as described above. In this ‘trained adaptation’ mode of operation, the update control signal is used to enable and disable the operation of the coefficient update unit 40 according to the occurrence (or availability) and duration of training signal data. As described above, training signals may be composed of bit patterns transmitted expressly for the purpose of adjusting compensator coefficients to existing channel conditions, or they may be composed of other bit patterns known to occur in the received data stream, such as the frame synchronization octets of SONET STS-192.

The IIR coefficient update mechanism operates as follows for its respective ‘decision-directed adaptation’ and ‘trained adaptation’ modes.

Decision-directed Adaptation Mode

As pointed out briefly above, in this mode of operation coefficient updates are based upon a comparison of the output of the IIR filter 30 with the output of the bit slicer 60. As an input serial signal stream is output from the photodiode detector 20 it is coupled to the lowpass filter 90. The output of the lowpass filter is coupled to the adjustable IIR filter 30. The output of the IIR filter 30 is coupled to the bit decision circuit 60 and over path B to the first input port 71 of the error generator 70. The output of the bit decision circuit 60 is coupled to the second input port 72 of the error generator 70 via paths C and G through the signal switch/selector 80. Namely in the decision-directed adaptation mode, the signal switch 80 connects the output (path C) of the bit decision circuit 60 to the second input port 72 of the error generator 70. (In the trained adaptation mode, on the other hand, the signal switch 80 connects an externally generated training signal on path D to the error generator 70.) The error generator 70 differentially combines the signals on its two inputs and supplies an error signal to input port 43 of the coefficient update unit 40. The coefficient update unit 40 implements or embodies an operator or algorithm (such as the IIR LMS, IIR SER, or other algorithm, as described above) designed to produce IIR filter coefficient updates, based upon the error signal input, that optimize some aspect of compensator performance. Depending on the specific update algorithm employed, the coefficient update unit 40 may also require IIR filter input and output signals as inputs. In this mode, IIR coefficients can be updated more or less continuously by enabling the coefficient update unit 40 with the update control signal coupled over path F to input port 44. The coefficient update control signal is generated by an external process or entity and may be used to disable the update process under different conditions including the reception of poor or unusable data.

Trained Adaptation Mode

As pointed out above, in this mode of operation coefficient updates are based upon a comparison of the output of the IIR filter 30 which is coupled to the first input port 71 of error generator 70, with an undistorted training signal from path D and coupled to the second input port 72 of the error generator 70 and supplied through the signal switch 80 from its input port 82. In this mode of operation, an external process or entity identifies the occurrence of known bit patterns in the received data stream and generates training signals based on undistorted versions of these patterns along with a corresponding synchronized “gating” signal (coefficient update control signal) and supplies these signals to the signal switch 80 input port 82 and the coefficient update unit 40 input port 44, respectively. The coefficient update control signal is used to enable/disable or “gate” the operation of the coefficient update unit 40 with the occurrence or availability of training data. Known bit patterns in the received data stream may correspond to patterns sent by the transmitter expressly for the purpose of training the compensator or they may correspond to other patterns known to occur in the data stream, such as the frame synchronization fields of SONET.

Combined and Other Adaptation Modes

In addition to using one of the above modes on an exclusive basis, the present invention also may use both filter adaptation modes, each being applied at different times under the control or supervision of an external process or operator. In this combined mode of operation, IIR filter coefficients may be updated or adjusted in accordance to a range of different criteria designed to optimize overall compensator performance. These criteria may include consideration of factors such as the quality of received data, other characteristics of received data, detection and classification of known bit patterns, probability of detection error and other factors. In this combined mode of operation, an external process or operator controls or supervises the mix and durations of decision-directed adaptation and trained adaptation through the use of the compensator's signal switch/select and coefficient update control signals.

It should be noted that in addition to the principal types described above, the compensator structure may be used to support other adaptation modes. For example, a ‘blind adaptation’ mode may be defined for the compensator by employing an algorithm or operator in the coefficient update unit whereby coefficient updates are generated based upon measured or derived quantities of selected signals.

While we have shown and described several embodiments in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

1. A method for processing an optical communication signal that has been transported over a dispersive optical communication channel, so as to recover an unknown information signal contained in said optical communication signal, comprising the steps of:
(a) converting said optical communication signal into an electrical communication signal; and
(b) filtering said electrical communication signal by means of an adaptive infinite impulse response (IIR) filter to produce a channel distortion-compensated output signal.

2. The method according to claim 1, wherein filtering said electrical communication signal includes updating weighting coefficients of said adaptive IIR filter by processing said channel distortion-compensated output signal and at least one of
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said optical communication signal,
prescribed statistics or other quantities of one or more system signals.

3. The method according to claim 2, wherein step (b) comprises updating weighting coefficients of said adaptive IIR filter by processing said channel distortion-compensated output signal and the output of said decision operator.

4. The method according to claim 3, wherein step (b) comprises generating weighting coefficients of said adaptive IIR filter by differentially combining said channel distortion-compensated output signal and the output of said decision operator to produce an error signal and coupling said error signal to a coefficient generator for said adaptive IIR filter.

5. The method according to claim 2, wherein step (b) comprises updating weighting coefficients of said adaptive IIR filter by processing said channel distortion-compensated output signal and an undistorted version of a known signal pattern contained in said optical communication signal.

6. The method according to claim 5, wherein step (b) comprises updating weighting coefficients of said adaptive IIR filter by differentially combining channel distortion-compensated output signal and an undistorted version of a known signal pattern contained in said optical communication signal to produce an error signal and coupling said error signal to a coefficient generator for said adaptive IIR filter.

7. The method according to claim 2, wherein said known signal pattern comprises a signal pattern exclusive of a training signal pattern.

8. The method according to claim 7, wherein said known signal pattern comprises a frame synchronization pattern.

9. The method according to claim 2, wherein step (b) comprises subjecting said channel distortion-compensated output signal and said at least one of the output of said decision operator and said undistorted version of a known signal pattern contained in said optical communication signal to a prescribed synthesis operator to produce synthesized versions thereof, and processing said synthesized versions to update weighting coefficients of said adaptive IIR filter.

10. The method according to claim 1, wherein step (b) includes updating weighting coefficients of said adaptive IIR filter by processing said channel distortion-compensated output signal and multiple ones of
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said optical communication signal, and
prescribed statistics or other quantities of one or more system signals.

11. The method according to claim 2, wherein step (b) comprises updating weighting coefficients of said adaptive IIR filter in accordance with said prescribed statistics or other quantities of one or more system signals.

12. The method according to claim 11, wherein step (b) comprises updating weighting coefficients of said adaptive IIR filter in accordance with prescribed statistics or other quantities of said electrical communication signal.

13. A receiver apparatus for processing an optical communication signal that has been transported over a dispersive optical communication channel, and recovering therefrom an unknown information signal contained in said optical communication signal, said receiver apparatus comprising:
an opto-electronic converter that is operative to convert said optical communication signal is into an electrical communication signal;
an adaptive infinite impulse response (IIR) filter coupled to filter said electrical communication signal and producing a channel distortion-compensated output signal; and
a coefficient update mechanism, which is operative to update weighting coefficients of said adaptive IIR filter.

14. The receiver apparatus according to claim 13, wherein said coefficient update mechanism is operative to update weighting coefficients of said adaptive IIR filter in accordance with at least one of:
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said optical communication signal, and
prescribed statistics or other quantities of one or more system signals.

15. The receiver apparatus according to claim 14, wherein said coefficient update mechanism is operative to update weighting coefficients of said adaptive IIR filter by processing said channel distortion-compensated output signal and the output of said decision operator.

16. The receiver apparatus according to claim 15, wherein coefficient update mechanism is operative to generate weighting coefficients of said adaptive IIR filter by differentially combining said channel distortion-compensated output signal and the output of said decision operator to produce an error signal and coupling said error signal to a coefficient generator for said adaptive IIR filter.

17. The receiver apparatus according to claim 14, wherein said coefficient update mechanism is operative to update weighting coefficients of said adaptive IIR filter by processing said channel distortion-compensated output signal and an undistorted version of a known signal pattern contained in said optical communication signal.

18. The receiver apparatus according to claim 17, wherein said coefficient update mechanism is operative to update weighting coefficients of said adaptive IIR filter by differentially combining channel distortion-compensated output signal and an undistorted version of a known signal pattern contained in said optical communication signal to produce an error signal and coupling said error signal to a coefficient generator for said adaptive IIR filter.

19. The receiver apparatus according to claim 14, wherein said known signal pattern comprises a signal pattern exclusive of a training signal pattern.

20. The receiver apparatus according to claim 19, wherein said known signal pattern comprises a frame synchronization pattern.

21. The receiver apparatus according to claim 14, wherein said coefficient update mechanism is operative to update weighting coefficients of said adaptive IIR filter in accordance with said prescribed statistics or other quantities of one or more system signals.

22. The receiver apparatus according to claim 21, wherein said coefficient update mechanism is operative to update weighting coefficients of said adaptive IIR filter in accordance with prescribed statistics or other quantities of said electrical communication signal.

23. A receiver apparatus for processing an optical communication signal that has been transported over a dispersive optical communication channel, and recovering therefrom an unknown information signal contained in said optical communication signal, said receiver apparatus comprising:
an opto-electronic converter that is operative to convert said optical communication signal is into an electrical communication signal;
an adaptive filter coupled to filter said electrical communication signal and producing a channel distortion-compensated output signal; and
a filter coefficient update mechanism, exclusive of said adaptive filter, and being operative to adaptively update weighting coefficients of said adaptive filter.

24. The receiver apparatus according to claim 23, wherein said filter update mechanism is operative to update weighting coefficients of said adaptive filter in accordance with at least one of:
the output of a decision operator to which said channel distortion-compensated output signal is coupled, said decision operator being operative to produce an output data stream in accordance with prescribed decision criteria applied to said channel distortion-compensated output signal,
an undistorted version of a known signal pattern contained in said optical communication signal and exclusive of a training signal, and
prescribed statistics or other quantities of one or more system signals.

25. The receiver apparatus according to claim 24, wherein said filter coefficient update mechanism is operative to subject said channel distortion-compensated output signal and said at least one of the output of said decision operator and said undistorted version of a known signal pattern contained in said optical communication signal to a prescribed synthesis operator to produce synthesized versions thereof, and to process said synthesized versions to update weighting coefficients of said adaptive filter.

26. The receiver apparatus according to claim 24, wherein said filter update mechanism is operative to update weighting coefficients of said adaptive filter in accordance with said prescribed statistics or other quantities of one or more system signals.

27. The receiver apparatus according to claim 26, wherein said filter update mechanism is operative to update weighting coefficients of said adaptive filter in accordance with prescribed statistics or other quantities of said electrical communication signal.
